(19) United States
(12) Patent Application Publication
(10) Pub. No.: US 2014/0168801 A1
(43) Pub. Date: Jun. 19, 2014

(54) COLLECTOR MIRROR FOR A SOLAR CONCENTRATOR COMPRISING LINEAR FRESNEL MIRRORS

(71) Applicant: Gang Xiao, Nice (FR)

(72) Inventor: Gang Xiao, Nice (FR)

(73) Assignees: CENTRE NATIONAL DE LA RECHERCHE SCIENTIFIQUE, Paris (FR); UNIVERSITE NICE SOPHIA-ANTIPOLIS, Nice (FR)

(21) Appl. No.: 14/232,519

(22) PCT Filed: Jul. 13, 2012
(86) PCT No.: PCT/FR2012/000292

§ 371 Date: Feb. 26, 2014

(30) Foreign Application Priority Data
Jul. 13, 2011 (FR) 11/02215

(51) Int. Cl. G02B 19/00

(52) U.S. Cl. CPC G02B 19/0023; G02B 19/0042
USPC 359/846

(57) ABSTRACT

The invention relates to a collector mirror (2) which is a component of a solar concentrator comprising linear Fresnel mirrors. The collector mirror (2) includes a reflective strip. The collector mirror (2) is provided with a device capable of generating a negative pressure (AP) behind the reflective strip (6).

### TECHNICAL FIELD OF THE INVENTION

The invention relates to the field of devices that collect solar heat and more particularly to the field of solar concentrators comprising linear Fresnel mirrors. It has for object a collector mirror constituting such a solar concentrator.

### PRIOR ART

WO 2010/083292 (Skyfuel, Inc) describes a solar concentrator comprising linear Fresnel mirrors. The solar concentrator comprises a plurality of collector mirrors and a receiver. Collector mirrors are intended to receive solar rays and to send the latter back to the receiver. As such, collector mirrors concentrate the solar rays on the receiver.

The collector mirrors are for example mirrors comprising a variable curvature. Such a variation in curvature is obtained using a device comprising pulleys and straps which, through their manoeuvring, are able to deform the collector mirror.

Such a collector mirror deserves to be improved in order to increase a rate of concentration of the solar rays on the receiver. In addition, such a collector mirror is complex and not very reliable. Finally, such a collector mirror has an optical precision that deserves to be improved.

### OBJECT OF THE INVENTION

The purpose of this invention is to propose a collector mirror for a solar concentrator comprising linear Fresnel mirrors that is light, easy to produce, reliable and robust, such a collector mirror able to increase a rate of concentration of solar rays on a receiver for the solar concentrator comprising linear Fresnel mirrors, such a collector mirror offering a suitable optical precision.

A mirror of this invention is a collector mirror for a solar concentrator comprising linear Fresnel mirrors. The collector mirror comprises a reflective strip.

According to this invention, the collector mirror is provided with a device capable of generating a negative pressure behind the reflective strip.

The device advantageously comprises the reflective strip and a membrane that jointly delimits and at least partially a chamber wherein the negative pressure is.

The device advantageously comprises means for aspirating the air contained inside the chamber, with such means of aspirating the air provided on the membrane.

The means for aspirating air are advantageously provided with means for controlling an aspiration speed.

The reflective strip is preferably carried by two longitudinal supports and a central support.

Preferably, at least one cable connects a leg of the central support and the longitudinal support to which the cable is assigned.

Preferably, at least one elastic strip is interposed between the cable and the longitudinal support to which the elastic strip is assigned.

Preferably, at least one accessory support extends parallel to the longitudinal supports.

Preferably, at least one additional support extends between the longitudinal supports.

The collector mirror is advantageously mobile in rotation around an axis of rotation parallel to a strip axis according to which the reflective strip is longitudinally extended.

A solar concentrator comprising linear Fresnel mirrors of this invention can mainly be recognised in that the solar concentrator comprising linear Fresnel mirrors comprises at least one such collector mirror.

The solar concentrator comprising linear Fresnel mirrors advantageously comprises a receiver which overhangs the collector mirror.

### DESCRIPTION OF THE FIGURES

Other characteristics and advantages of this invention shall appear in the description that shall be made of it of example embodiments, in relation with the figures of the annexed plates, wherein:

FIG. 1 is a diagrammatical view in perspective of a solar concentrator comprising linear Fresnel mirrors of this invention.

FIG. 2 is a schematic top view of a collector mirror for the solar concentrator comprising linear Fresnel mirrors shown in the preceding figure.

FIG. 3 is a partial diagrammatical view and in perspective of the collector mirror shown in the preceding figure.

FIG. 4 is a diagrammatical cross-section view of the collector mirror shown in FIGS. 2 and 3 according to two separate positions.

FIGS. 5 to 7 are partial views in perspective of the collector mirror shown in FIGS. 2 to 4.

FIG. 8 is a perspective view of the collector mirror shown in FIGS. 2 to 7;

FIG. 9A shows the rear surface of a reflective strip of a collector mirror according to the invention, provided with conforming profiles; and

FIG. 9B shows the detail of a conforming profile of a collector mirror according to the invention.

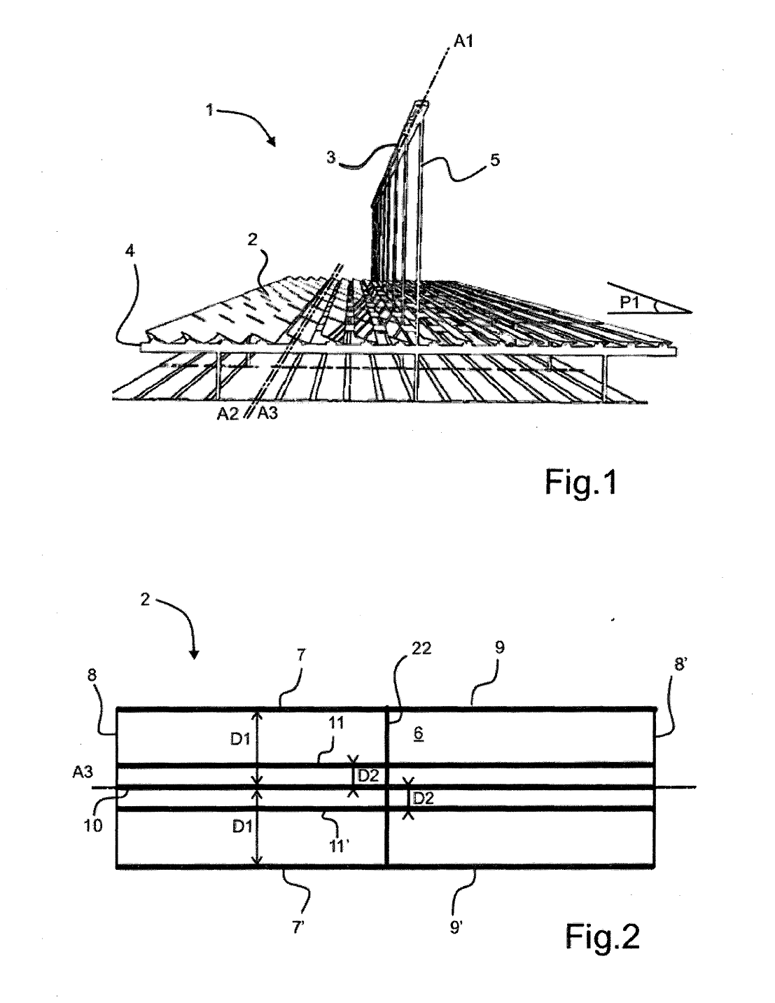

In FIG. 1, a solar concentrator comprising linear Fresnel mirrors 1 comprises a plurality of collector mirrors 2 and a receiver 3. The collector mirrors 2 are intended to receive solar rays and to send the latter back to the receiver 3. The latter is for example conformed as a cylindrical tube inside of which flows a heat transfer medium. The cylindrical tube is generally linear and extends according to an axis of tube A1. The solar rays concentrated on the receiver 2 make it possible to raise the temperature of the heat transfer medium. Such an elevation in temperature can either be used directly as a source of energy, or transformed into electrical energy by the intermediary of a turbine or similar.

The collector mirrors 2 are carried by a structure 4 arranged in a frame that overhangs the receiver 3. The frame is generally conformed according to a plane of the frame P1 which is parallel to the axis of tube A1. The structure 4 comprises poles 5 that emerge above the structure 4, substantially perpendicularly to the plane of the frame P1. The poles 5 constitute supports for the receiver 3. Each collector mirror 2 is mobile in rotation around a single axis of rotation A2 which is substantially parallel to the axis of tube A1.

In FIG. 2, the collector mirror 2 comprises a reflective strip 6 which is elongated according to a strip axis A3 which is parallel to the axis of rotation A2. The reflective strip 6 comprises two longitudinal edges 7, 1′ which are parallel to one another and parallel to the strip axis A3. The reflective strip 6 also comprises two transversal edges 8, 8′ which are parallel to one another and orthogonal to the strip axis A3. The reflective strip 6 is carried by two longitudinal supports 9, 9′ which are respectively assigned to the longitudinal edges 7, 7′. The reflective strip 6 is also carried by at least one central support 10 which is arranged parallel to the longitudinal supports 9, 9′. The central support is arranged at a first distance D1 from each of the longitudinal supports 9, 9′. Preferably, the reflective strip 6 is also carried by two accessory supports 11, 11′ which are arranged parallel to the central support 10 and on either side of the latter. Each accessory support 11, 11′ is placed at a second distance D2 from the central support 10 which is 20% less than the first distance D1, and which is preferably of a magnitude of 10% of the first distance D1.

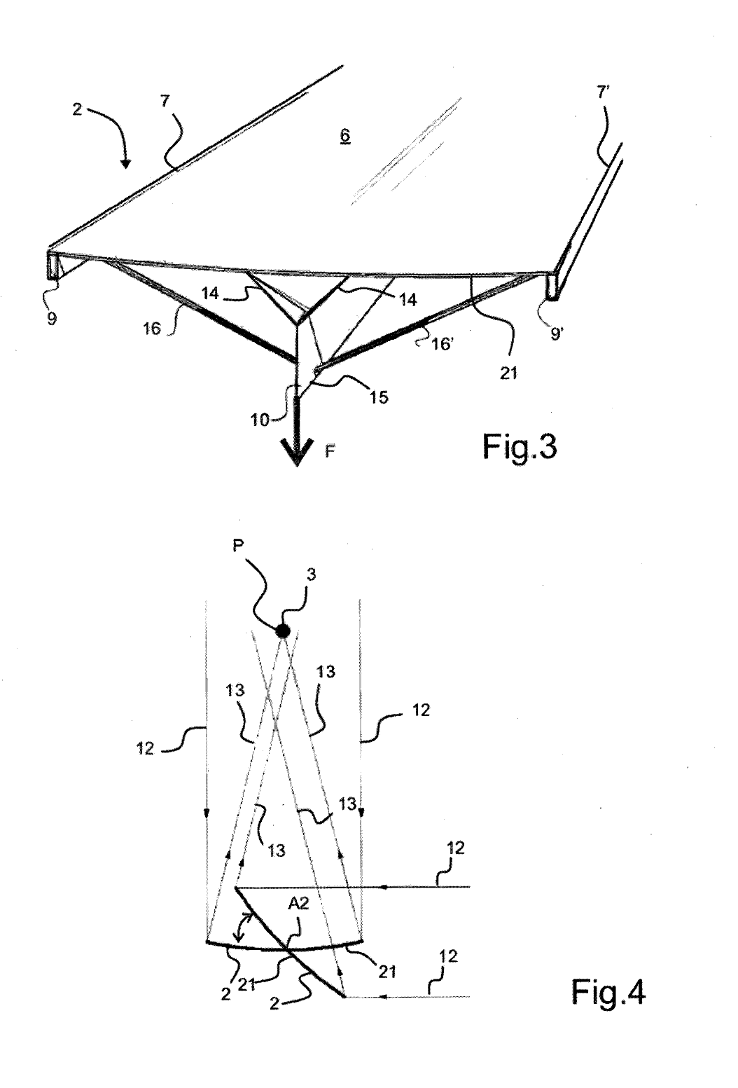

According to this invention, a suction force F is applied to the reflective strip 6 in such a way as to deform the latter. Such a deformation provides the reflective strip 6 with a curvature such that the reflective strip 6 constitutes a convergent lens with focal point P, with the latter being confounded with the receiver 3, as shown in FIG. 3. In other words, the suction force F provides the reflective strip 6 with a geometry such that incident solar rays 12 are transformed into reflected rays 13 which are concentrated on the receiver 3, regardless of the position of the collector mirror 2 during its rotation about the axis of rotation A2. To this effect, the suction force F is of a variable amplitude in order to be able to adapt the focal point P on the receiver 3. These provisions are such that, as the collector mirror 2 is able to follow the course of the sun, producer of incident rays 12, in order to concentrate the incident rays 12 on the receiver 3. This results in an improvement in the optical precision of such a solar concentrator 1.

A suction force F generated by a level of negative pressure behind a reflective strip in a mirror according to the invention does not make it possible to obtain a radius of circular curvature of this strip, which is a radius of curvature in an arc of a circle. Yet, such a curvature is required so that the focal line of the mirrors is confounded with the axis of the receiver tube and this, dynamically. Because of this, the mirrors according to the invention are advantageously provided with means that make it possible to dynamically control the curvature of the reflective strips in such a way that the latter is in an arc of circle and the rest even when the negative pressure created behind the reflective strip varies dynamically, according to the course of the sun.

In reference again to FIG. 3, the central support 10 is conformed as a “Y” comprising two arms 14 which are in relation with the reflective strip 6 and a leg 15 which is provided with a plurality of cables 16, 16′. The cables 16, 16′ are respectively in relation with the longitudinal supports 9, 9′ in such a way as to increase the curvature of the reflective strip 6 on the longitudinal edges 7, 7′. The cables 16, 16′ are able to comprise a respective elasticity that is separate from one another in order to be able to adjust a traction of the longitudinal support 9, 9′ to which it is assigned, aiming to homogenise a curvature of the reflective strip 6 over its entire width, i.e. parallel to the transversal edges 8, 8′. These provisions are such that it is possible to concentrate the reflected rays 13 on the receiver 3, including when the collector mirror 2 is not perpendicularly arranged facing the receiver 3.

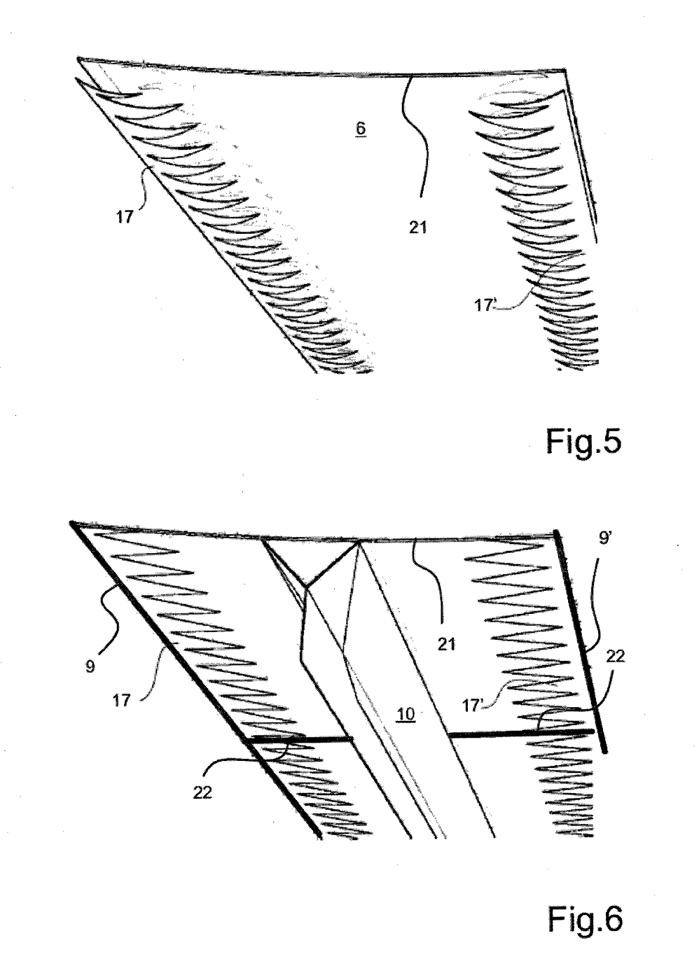

In FIG. 5 and FIG. 6, elastic strips 17, 17′ are interposed between the longitudinal edge 7, 7′ to which they are respectively assigned and the cable 16, 16′ that connects said longitudinal edge 7, 7′ and the leg 15 of the central support 10. The elastic strips 17, 17′ make it possible to adapt the curvature of the reflective strip 6 over the longitudinal edge 7, 7′ that the elastic strips 17, 17′ are provided on respectively.

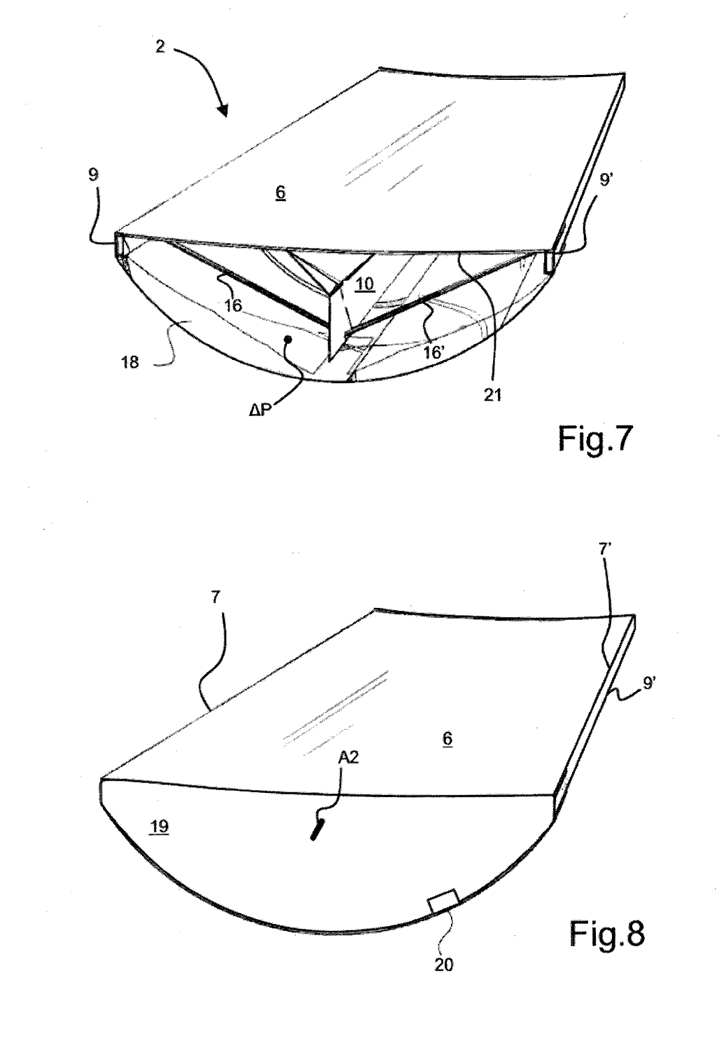

In FIG. 7, a membrane 18 delimits a chamber 19 inside of which is housed the central support 10. In other words, the chamber 19 is delimited by the reflective strip 6 and the membrane 18 which are joined together by the intermediary of the longitudinal edges 7, 7′ and of the transversal edges 8, 8′. Note that, according to the invention, the reflective strip 6 of each mirror 2 is subjected to a single level of difference in pressure in relation to atmospheric pressure—a single level of negative pressure. This level of negative pressure is formed behind the reflective strip. In front of the latter, i.e. at the surface of the strip that reflects the incident rays of the sun, there is no chamber of negative pressure and the pressure is equal to the pressure of the surrounding exterior, which is atmospheric pressure.

According to the invention, the curvature of the reflective strips 6 of the mirrors 2 is modified dynamically, according to the incident angle of the solar rays, therefore according to the course of the sun. Taking into account the fact that the reflective strip 6 is subjected to a single level of negative pressure, the dynamic modification of the curvature of this reflective strip can be carried out immediately, by adjusting the negative pressure in the chamber of single negative pressure, behind the strip 6. Furthermore, in the mirrors according to the invention, nothing interferes with the incident rays of the sun. The latter are not subjected to any reflection or diffraction or absorption by passing through an element that would be placed in front of the reflective strip. The losses are as such zero.

In FIG. 8, the membrane 18 is provided with means of aspirating 20 the air contained inside the chamber 19, in order to create a negative pressure AP inside the latter. The means of aspirating 20 are for example constituted of a fan, an air pump or similar. The means of aspirating 20 are able to cause a flow of air to flow from the chamber 19 to an environment outside the chamber 19. Such a negative pressure ΔP is generated behind the reflective strip 6, i.e. against a rear surface 21 of the reflective strip 6 which is the surface opposite that receiving the incident rays 12. Such a negative pressure ΔP creates the suction force F that causes the curved arrangement of the reflective strip 6. The means for aspirating 20 are provided with means of controlling an air suction speed, in such a way that the negative pressure ΔP inside the chamber 19 is controlled in order to define with precision the curvature of the reflective strip 6.

The cables 16, 16′ and/or the elastic strips 17, 17′ have an elasticity such that the central support 10 absorbs approximately 20% to 40% of a constraint that is applied to it. In the preferred case wherein the distance between the arms 14 is of a magnitude of 20% of the first distance D1, an optical aberration of a reflection of the incident rays on the reflective strip 6 due to an imperfection in the curvature is less than 1.5% of a width of the reflective strip 6, with such a width being equal to double the first distance D1.

Such a collector mirror 2 has the advantage of not being very sensitive to a harmful action of the wind due to a rigidity of the longitudinal supports 9, 9′, of the central support 10 and of the accessory supports 11, 11′.

In reference again to FIG. 6, such a resistance to the wind is reinforced by at least one additional support 22 which is arranged substantially perpendicularly to the axis of rotation A2 of each collector mirror 2. The additional support 22 extends on either side of the central support 10 between the longitudinal supports 9, 9′. The additional support 22 preferably comprises a maximum moment of inertia at its centre. In the case where the additional supports 22 are of a plurality, the additional supports 22 comprise a rigidity and a spacing between them such that the collector mirror 2 has a uniform curvature. This then results in a negative pressure ΔP which is in particular between 2 mbar and 50 mbar, a maximum negative pressure ΔP offering a maximum resistance to the wind.

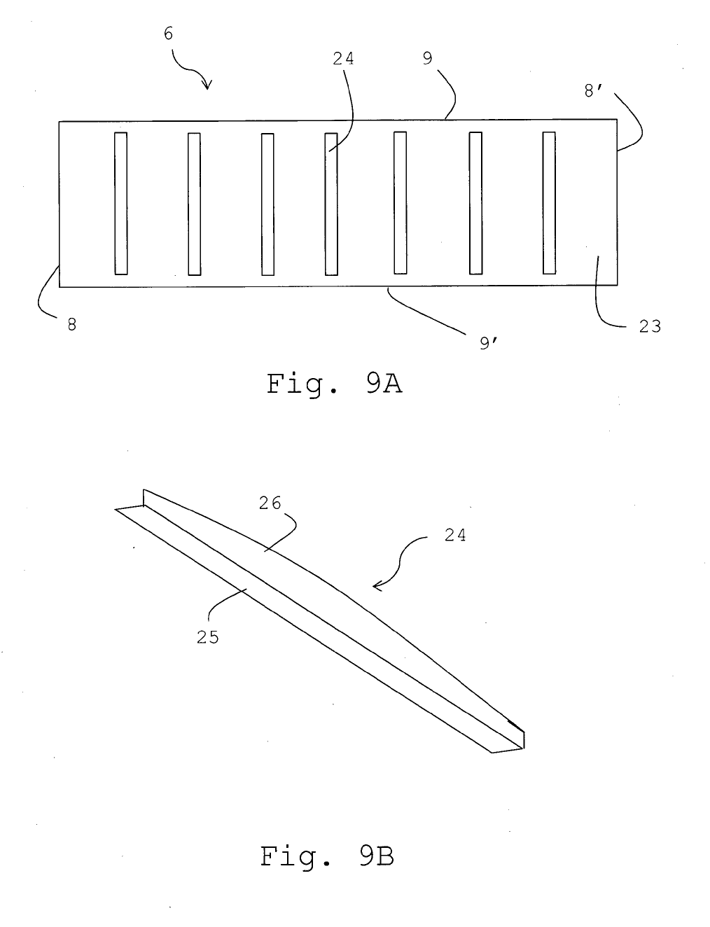

In the embodiment shown in FIG. 9A, the reflective strip 6 is provided, at its rear surface 23, i.e. the surface opposite that which reflects the incident light of the sun, with a plurality of conforming profiles 24, for example approximately ten profiles, substantially linear, arranged substantially parallel to one another, at an equal distance from one another, substantially parallel to the transversal edges 8, 8′, which is substantially orthogonal to the longitudinal edges 9, 9′. Such as is shown in, detail in FIG. 9B, each conforming profile 24 has a shoulder 25 that provides the fastening of the profile to the rear surface 23 of the reflective strip 6. It further comprises a conforming element 26, in the example in FIG. 9B, a profile substantially perpendicular to the shoulder, which is higher in its central portion, than at its ends. Because of this, the confirming profiles have a rigidity that is more substantial at their centre than at their ends. This rigidity decreases from the centre towards the ends according to a decay curve that makes it possible to correct the non-circular curvature profile of the reflective strip. In the absence of means for correcting the curvature of the reflective strip, the latter has a radius of curvature that is more substantial at its centre than at its ends. As the rigidity of the conforming profiles is more substantial at their centre that at their ends, the radiuses of curvature are corrected and become substantially the same along the surface of the reflective strip. Moreover, the profiles reinforce the resistance of the mirrors to the action of the wind.

According to an embodiment, the solar concentrator comprising linear Fresnel mirrors 1 of this invention comprises eight collector mirrors 2 with a width of one metre. Each reflective strip 6 is comprised of a glass slide with a thickness of a magnitude of 4 mm. A distance between the receiver 3 and a collector mirror 2 is of a magnitude of eight metres and an angle of forty-two degrees is formed between a vertical and a straight line connecting the receiver 3 and the strip axis A3. The reflective strip 6 comprises a radius of curvature of sixteen metres when the reflective strip 6 is facing the receiver 3 and a radius of curvature of twenty-five metres when the sun is at thirty degrees above the horizon. The first distance D1 is of a magnitude of ten centimetres. The negative pressure is of a magnitude of 0.5 mbar to 5 mbar. In this case, the variation of the radius of curvature of sixteen metres to twenty-five metres is possible with a maximum deviation of the reflected rays 13 of a magnitude of 1%.

All of these provisions are such that an optical aberration of the collector mirror 2 is less than 2% of a width of the reflective strip 6. All of these provisions are further such that an opening of the receiver 3 is less than 16% of said width. This results in a reduction in the heat losses through radiation and by conduction on receiver 3. This also results in a solar concentrator comprising linear Fresnel mirrors 1 with a low cost using a receiver 3 having an opening of small dimension, using a reduced number of collector mirrors 2.

1. Collector mirror for a solar concentrator comprising linear Fresnel mirrors, the collector mirror comprising a reflective strip, characterised in that the collector mirror is provided with a device capable of generating a negative pressure controlled behind the reflective strip, in order to apply a suction force to said strip, this force being of variable amplitude.

2. Collector mirror as claimed in claim 1, wherein the device comprises the reflective strip and a membrane that jointly delimits and at least partially a chamber inside of which the negative pressure is.

3. Collector mirror as claimed in claim 1, wherein the device comprises means for aspirating air contained inside the chamber, such means for aspirating air provided on the membrane.

4. Collector mirror according to claim 3, wherein the means for aspirating air are advantageously provided with means of control of a suction speed.

5. Collector mirror as claimed in claim 1, wherein the reflective strip is carried by two longitudinal supports and a central support.

6. Collector mirror according to claim 5, wherein at least one cable connects a leg of the central support and the longitudinal support to which the cable is assigned.

7. Collector mirror according to claim 6, wherein at least one elastic strip is interposed between the cable and the longitudinal support to which the elastic strip is assigned.

8. Collector mirror according to claim 6, wherein at least one accessory support extends parallel to the longitudinal supports.

9. Collector mirror according to claim 6, wherein at least one additional support extends between the longitudinal supports.

10. Collector mirror as claimed in claim 1, wherein the collector mirror is mobile in rotation about an axis of rotation parallel to a strip axis according to which the reflective strip is longitudinally extended.

11. Collector mirror according to claim 1, wherein the reflective strip is subjected to a single level of difference of pressure in relation to atmospheric pressure, in that this level of difference in pressure is a level of negative pressure and in that the negative pressure is applied to the rear surface of the reflective strip, with the pressure at the front surface of this strip being equal to atmospheric pressure.

12. Collector mirror according to claim 1, comprising means for correcting the non-circular curvature of the reflective strip.

13. Collector mirror according to claim 12, wherein these means for correcting include conforming profiles that have a rigidity that is more substantial at their centre that at their ends.

14. Collector mirror according to claim 1, wherein the curvature of the reflective strip varies dynamically over time according to the course of the sun.

15. Solar concentrator comprising linear Fresnel mirrors comprising at least one collector mirror as claimed in claim 1.

16. Solar concentrator comprising linear Fresnel mirrors according to claim 15, wherein the solar concentrator comprising linear Fresnel mirrors comprises a receiver which overhangs the collector mirror.

17. Collector mirror as claimed in claim 2, wherein the device comprises means for aspirating air contained inside the chamber, such means for aspirating air provided on the membrane.

18. Collector mirror according to claim 17, wherein the means for aspirating air are advantageously provided with means of control of a suction speed.

19. Collector mirror as claimed in claim 2, wherein the reflective strip is carried by two longitudinal supports and a central support.

20. Collector mirror as claimed in claim 3, wherein the reflective strip is carried by two longitudinal supports and a central support.
